(19) United States
(12) Patent Application Publication
(10) Pub. No.: US 2021/0270431 A1
(43) Pub. Date: Sep. 2, 2021

(54) LED Strip with Connectors

(71) Applicant: Elemental LED, Inc., Reno, NV (US)

(72) Inventor: Matthew John, Reno, NV (US)

(21) Appl. No.: 17/184,971

(22) Filed: Feb. 25, 2021

Related U.S. Application Data
(60) Provisional application No. 62/982,857, filed on Feb. 28, 2020.

(51) Int. Cl. F21S 4/22; F21V 23/06; H01R 25/00; H01R 12/71; H01R 12/77; H01R 13/717; H01R 13/514

(52) U.S. Cl. CPC F21S 4/22; F21V 23/06; H01R 25/00; H01R 13/514; H01R 12/778; H01R 13/7175; H01R 12/712

(57) ABSTRACT

Lighting and power strips are disclosed. The lighting and power strips include an elongate, narrow printed circuit board (PCB) on which one or both of USB connectors or number of LED light engines are mounted. The PCB may be rigid or narrow, and is typically divided into repeating blocks, with at least one connector and at least one LED light engine in each repeating block. The PCB may be backed by a layer of pressure-sensitive adhesive.

### CROSS-REFERENCE TO RELATED APPLICATIONS

This application claims priority to, and the benefit of, U.S. Provisional Patent Application No. 62/982,857, filed Feb. 28, 2020. The contents of that application are incorporated by reference herein in their entirety.

### TECHNICAL FIELD

The invention relates to LED strip with connectors.

### BACKGROUND

Lighting based on light-emitting diodes (LEDs) has supplanted traditional incandescent and fluorescent lighting to become a mainstay of the residential and commercial lighting markets. Linear lighting is a particular class of LED lighting in which an elongate, narrow printed circuit board (PCB) is populated with a number of LED light engines, spaced from one another at a regular pitch or spacing. The PCB itself may be either flexible or rigid.

Linear lighting typically operates at low voltage using direct current (DC) power. Although the definition of “low voltage” varies according to the authority one consults, for purposes of this description, low voltage should be construed to refer to any voltage under about 50V. Since most household and commercial power systems operate using high-voltage alternating current (AC) power, LED lighting systems often require their own power infrastructure. Typically, the component that converts high-voltage AC to low-voltage DC is called a driver. A driver may be any form of electrical circuitry that is capable of converting high-voltage AC to low-voltage DC, and is often a form of switched-mode power supply.

In addition to the driver itself, other types of systems are often used to convert and convey power to linear lighting. U.S. Pat. No. 9,537,274, the contents of which are incorporated by reference in their entirety, discloses a system in which rigid PCBs with connectors surface-mounted on them are used to convey power to low-voltage linear lighting. U.S. Patent Application Publication No. 2019/0049077, the contents of which are also incorporated by reference in their entirety, discloses a similar system that uses flexible PCBs. While these systems are useful, the connectors that are used are specialized, which limits the applicability of the systems.

### BRIEF SUMMARY

One aspect of the invention relates to a power strip. The power strip comprises a narrow, elongate printed circuit board (PCB) on which a plurality of USB connectors are mounted, spaced apart at a regular spacing or pitch. The PCB may be rigid or flexible, and may be divided into repeating blocks, which are separable from each other at cut points. At least one of the plurality of USB connectors is typically in each of the repeating blocks.

Another aspect of the invention relates to a lighting and power strip. The lighting and power strip comprises a narrow, elongate printed circuit board (PCB) on which a plurality of USB connectors are mounted, spaced apart at a regular spacing or pitch. A plurality of LED light engines are also mounted The PCB may be rigid or flexible, and may be divided into repeating blocks, which are separable from each other at cut points. At least one of the plurality of USB connectors and at least one of the plurality of LED light engines is typically in each of the repeating blocks.

Yet another aspect of the invention relates to methods for installing and using lighting and power strips like those described above. In methods according to this aspect of the invention, a lighting and power strip is cut to a desired length and adhered to a desired surface using a layer of pressure-sensitive adhesive on its reverse. The desired surface may be a curved surface, such as a pole, or the lighting and power strip may be applied around a corner.

A further aspect of the invention relates to USB hubs and charging stations using lighting and power strips. The USB hubs and charging stations include a lighting and power strip, a power source, and at least one USB cable connecting the lighting and power strip to the power source.

Other aspects, features, and advantages of the invention are set forth in the description that follows.

### BRIEF DESCRIPTION OF THE DRAWING FIGURES

The invention will be described with respect to the following drawing figures, in which like numerals represent like features throughout the application, and in which:

FIG. 1 is a perspective view of a power connector strip according to one embodiment of the invention;

FIG. 2 is a perspective view of a lighting and power strip according to another embodiment of the invention;

FIG. 3 is a perspective view illustrating the interconnection of two of the lighting and power strips of FIG. 2; and

FIG. 4 is a perspective view of a power connector strip according to another embodiment of the invention.

### DETAILED DESCRIPTION

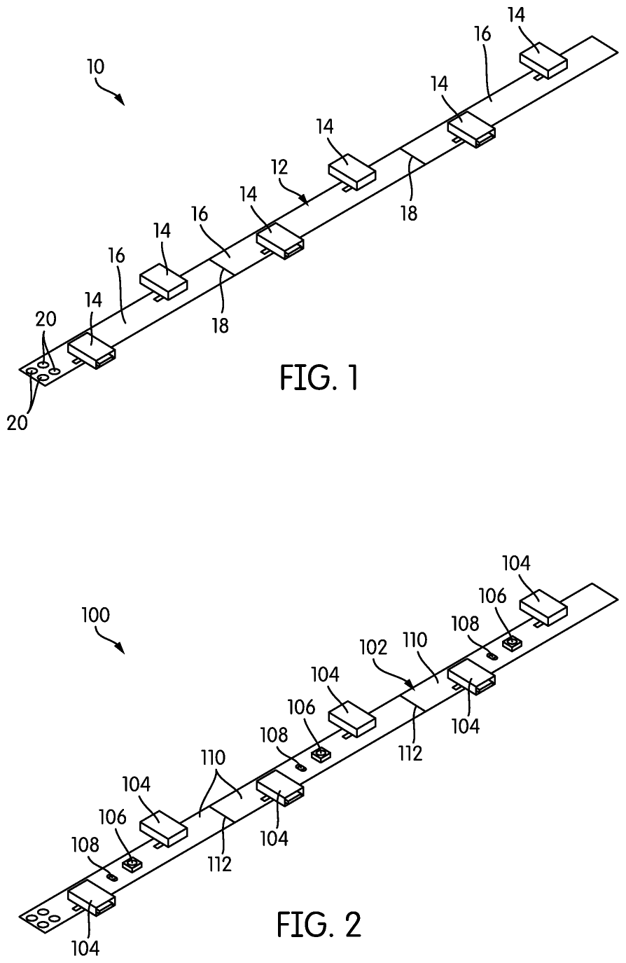

FIG. 1 is a perspective view of a power connector strip, generally indicated at 10, according to one embodiment of the invention. The power connector strip 10 comprises a printed circuit board (PCB) 12 on which a plurality of connectors 14 are disposed.

The PCB 12 may be either rigid or flexible. If rigid, it may be made of a material such as FR4 composite or aluminum. If flexible, the PCB 12 may be made of a polymeric material such as polyimide or MYLAR® (biaxially-oriented polyethylene terephthalate). Of course, in sufficiently thin section, any number of materials would have the necessary flexibility to be considered flexible. For purposes of this description, a PCB 12 can be considered to be flexible if it bends under its own weight.

In FIG. 1, the connectors 14 are surface-mounted on the PCB 12. In other embodiments, other methods of mounting the connectors 14 may be used, including through-hole mounting. The connectors 14 are spaced from one another on the PCB 12 at a regular pitch or spacing along the entire length of the PCB 12, although irregular spacings and variable pitches may be used in other embodiments.

The PCB 12 is divided into repeating blocks 16, three of which are shown in FIG. 1. Each repeating block 16 is a self-contained electrical unit; separated from the rest of the PCB 12, the repeating block 16 will function. Electrically, depending on the embodiment, the repeating blocks 16 may be arranged either in series or in parallel with one another. If the repeating blocks 16 are in series with one another, additional conductors or other such structures may be provided so that the failure of a single conductor, or a single set of conductors, in one repeating block 16 does not result in the failure of all of the repeating blocks 16 in the power connector strip 10. In FIG. 1, the repeating blocks 16 can be cut at specific cut lines 18 that are printed on the face of the PCB 12, although specific cut lines 18 need not be indicated in all embodiments.

Typically, the PCB 12 is elongate and narrow, ranging in width from, e.g., 5-14 mm (0.2-0.6 in). Power connector strips 10 of this type may be made in arbitrarily long lengths by connecting strips of PCB 12 together at overlapping soldered joints, colloquially called “lap joints.” On the PCB 12, solder pads 20 are provided at one end of the PCB for this type of overlapping connection, although solder pads 20 may be provided at both ends in other embodiments. There may be more solder pads 20 than there are contact traces requiring connection if additional solder pads 20 will help to align adjacent segments of PCB 12 during the manufacturing process.

In the illustrated embodiment, the connectors 14 are female universal serial bus (USB) type A connectors. The connectors 14 alternate in direction, two to a repeating block 16, down the length of the power connector strip 10. While USB-A connectors are shown in FIG. 1, any type of USB connector could be used, including Types B and C and the mini- and micro-type connectors.

USB-standard connectors are widely used in industry both for communicating data between peripherals and computer systems, and for powering small devices. Depending on the embodiment, the connectors 14 may be connected only to power conductors, or to both power and data conductors.

The USB data and battery charging standards use a voltage of 5V, while USB power delivery standards use a voltage of 20V. Maximum current draw with these standards is usually either 3 A or 5 A. These voltages and amperages are compatible with the U.S. National Electrical Code standard for Class 2 low-voltage circuits, which are required to draw no more than 100 W of power. These voltages and amperages are also compatible with the voltage and current levels used to power LED light engines.

In some cases, it may be helpful to provide a strip that includes both connectors 14 and LED light engines. The LED light engines provide several advantages: they serve as indicator lighting to indicate that power is flowing through the circuit. They may also be used for either general or task illumination.

FIG. 2 is an illustration of a lighting and power connector strip, generally indicated at 100, according to another embodiment of the invention. Mounted on the PCB 102 are both a number of connectors 104 and a number of LED light engines 106.

As the term is used here, “light engine” refers to an element in which one or more light-emitting diodes (LEDs) are packaged, along with wires and other structures, such as electrical contacts, that are needed to connect the light engine to a PCB. LED light engines may emit a single color of light, or they may include red-green-blue (RGBs) that, together, are capable of emitting a variety of different colors depending on the input voltages. If the light engine is intended to emit “white” light, it may be a so-called “blue pump” light engine in which a light engine containing one or more blue-emitting LEDs (e.g., InGaN LEDs) is covered with a phosphor, a chemical compound that absorbs the emitted blue light and re-emits either a broader or a different spectrum of wavelengths. The particular type of LED light engine is not critical to the invention. In the illustrated embodiment, the light engines 106 are surface-mount devices (SMDs) soldered to the PCB 102, although other types of light engines and mounting techniques may be used.

To make a functional strip 100 that includes LED light engines 106, other components may be mounted on the PCB 102. In a typical power circuit for LED light engines, the current flow to the light engines is controlled. This may be done in the power supply, or it may be done by adding components to the PCB 12 to manage current flow. Linear lighting that is designed to be used with a power supply that controls the current flow is called “constant current” linear lighting. Linear lighting that is designed to control the current flow using its own circuits is often referred to as “constant voltage” linear lighting. Constant-current linear lighting is often used when the length of the linear lighting is known in advance; constant-voltage linear lighting is more versatile and more easily used in situations where the length, and resulting current draw, is unknown or is likely to vary from one installation to the next.

For purposes of this description, the strip 100 is assumed to be constant-voltage with respect to the light engines 106, and current control components 108 are shown surface-mounted on the PCB 102. In practice, passive circuit elements like resistors are suitable current control components 108, although some linear lighting may use active circuit elements, like current control integrated circuits. As those of skill in the art will appreciate, if the light engine 106 requires several separate sets of inputs, as would be the case for RGB light engines or for light engines capable of producing several different color temperatures of light, a current control component 108, such as a resistor, is usually needed in the circuit for each of the sets of inputs. Thus, although one current control component 108 is shown in each repeating block 110 in the embodiment of FIG. 2, several may be present in each repeating block 110 in other embodiments. In other cases, the connectors 104 and their connections and circuitry may provide enough resistance to reduce or eliminate the need for specific current control components 108 for the LED light engines 106.

In the strip 100 of FIG. 2, there is one LED light engine 106 per repeating block 110. The number of LED light engines 106 per repeating block 100 will vary depending on the forward voltages of the LED light engines 106 and other conventional factors. Many LED light engines 106 have forward voltages between 1.8V and 3.3V, which means that in a single repeating block 110 operating at 5V, there may be 1-2 LED light engines 106. Cut lines 112 that divide repeating blocks 110 are indicated on the PCB 102.

Because the strips 10, 100 use standard USB connectors, they can be used to connect and power any number of types of devices. Additionally, they can be connected to power by standard cables. This is a major advantage over traditional LED linear lighting, which is typically soldered to power leads. Traditional power strips may also require soldered connections to power leads or other special wiring to connect to power.

The lighting and power strips 10, 100 disclosed here may have a pressure-sensitive adhesive layer on the underside of the PCB 12, 102 so that they can be installed on a variety of surfaces. The adhesive layer would typically be protected by a release strip. The resulting strips 10, 100 can be installed nearly anywhere, and are particularly suitable for installation in recessed grooves, under overhangs, and in other such places where they can provide both power and, in strips 100 that include LED light engines 106, task or general lighting.

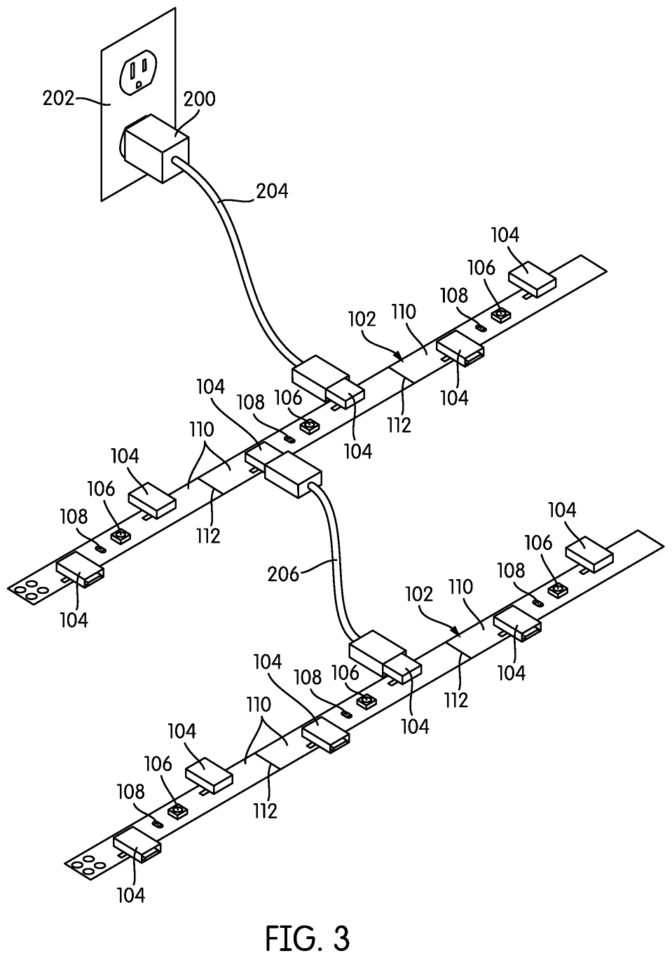

FIG. 3 illustrates one potential way in which lighting and power strips 10, 100 may be used. Specifically, two lighting and power strips 102 are shown in the view of FIG. 3. A USB charger 200 is plugged into a wall outlet 202. A USB cable 204 is plugged into the charger 200 at one end and connected to a connector 104 at the other end. The USB cable 204 thus provides power to the lighting and power strip 100. A second USB cable 206 jumpers between the first lighting and power strip 100 and a second lighting and power strip 100.

In these sorts of arrangements, any of the connectors 104 may be used for input and any of the connectors 104 may be used for output. By their standard, USB cables have a relatively short maximum length because of Ohmic voltage drop and other issues. If needed, power could be supplied into several of the connectors 104 spaced along the PCB 102 in order to extend the effective length of the system.

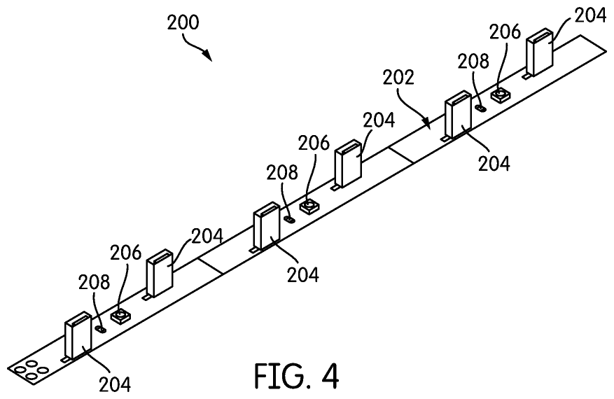

The orientation of connectors 14, 104 shown in FIGS. 1-3 are not the only possible orientations possible. FIG. 4 is a perspective view of a lighting and power strip, generally indicated at 200, according to another embodiment of the invention. The lighting and power strip 200 includes a PCB 202. Mounted on the PCB 202 are both a number of connectors 204 and a number of LED light engines 206. Current control components 208 are shown surface-mounted on the PCB 202. In short, the lighting and power strip 200 is similar to the lighting and power strip 100 described above. The difference between the two 100, 200 lies in the orientation of the mounted connectors 204: the connectors 204 extend upward from the PCB 202, instead of to one side or the other.

The lighting and power strips 10, 100, 200 described here have particular use as USB charging stations and hubs. Any of the lighting and power strips 10, 100, 200 described here may be manufactured in great lengths, e.g., in spools up to 400 feet (100 meters). If a power station or USB hub is needed, a section of power strip 10 or lighting and power strip 100, 200 can be cut to essentially any desired length by cutting at a cut point 18, 112. The resulting length of strip 10, 100, 200 can be stuck virtually anywhere using pressure-sensitive adhesive on the reverse of the strip 10, 100, 200 and connected to power via a USB cable. As was noted briefly above, in some embodiments, the strip 10, 100, 200 may carry both power and data.

Power stations and USB hubs made using lighting and power strips 10, 100, 200 according to embodiments of the invention may be ad hoc—assembled quickly, and torn down when no longer needed. Moreover, these types of power stations and USB hubs can be placed where traditional charging stations and hubs cannot. For example, if the PCB 12, 102, 202 is flexible, a power station/USB hub can be wrapped around a post, or flexed around a corner, providing power, data, or both essentially wherever needed. U.S. Patent Application Publication No. 2019/0049077, which was incorporated by reference above, discloses PCB that is structured so that it can be bent in multiple planes—so called “squiggly” PCB—and particularly for power-only or short-distance applications, that type of PCB could be used in embodiments of the lighting and power strips described here.

Although portions of this description assume compliance with the USB standard, that need not always be the case. In some embodiments, USB-style cables may be used, but the voltage and/or current levels may be increased up to the physical capacity (i.e., ampacity) of the conductors. Additionally, as those of skill in the art will realize, although USB connectors are described here, any sort of widely-used connector may be used.

While the invention has been described with respect to certain embodiments, the description is intended to be exemplary, rather than limiting. Modifications and changes may be made within the scope of the invention, which is defined by the appended claims.

What is claimed is:

1. A power strip, comprising:
a narrow, elongate printed circuit board (PCB); and
a plurality of USB connectors mounted on the PCB, spaced from each other at a regular pitch.

2. The power strip of claim 1, wherein the PCB is rigid.

3. The power strip of claim 1, wherein the PCB is flexible.

4. The power strip of claim 1, wherein the PCB is divided into repeating blocks with at least one of the plurality of USB connectors in each repeating block.

5. The power strip of claim 1, wherein the PCB is flexible, divided into repeating blocks with at least one of the plurality of USB connectors in each repeating block, and the repeating blocks are divisible from one another at cut points.

6. A power and light strip, comprising:
a narrow, elongate printed circuit board (PCB);
a plurality of USB connectors mounted on the PCB, spaced from each other at a regular pitch; and
a plurality of LED light engines mounted on the PCB, spaced from each other at a regular pitch.

7. The power strip of claim 6, wherein the PCB is rigid.

8. The power strip of claim 6, wherein the PCB is flexible.

9. The power strip of claim 6, wherein the PCB is divided into repeating blocks with at least one of the plurality of USB connectors and at least one of the plurality of LED light engines in each repeating block.

10. The power strip of claim 9, wherein the PCB is flexible.

11. The power strip of claim 10, wherein the repeating blocks are divisible from one another at cut points.
